(19) United States
(12) Patent Application Publication
(10) Pub. No.: US 2006/0094446 A1
(43) Pub. Date: May 4, 2006

(54) Method for limiting quantity of location information request flows in location service

(75) Inventor: Xiaoqin Duan, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies, Co., Ltd., Shenzhen (CN)

(21) Appl. No.: 11/244,480

(22) Filed: Oct. 6, 2005

Related U.S. Application Data
(63) Continuation of application No. PCT/CN04/00313, filed on Apr. 5, 2004.

(30) Foreign Application Priority Data
Apr. 7, 2003 (CN) 03109249.7

(51) Int. Cl. H04Q 7/20

(52) U.S. Cl. 455/456.3

(57) ABSTRACT

Disclosed is a method for restricting Location request flow in location service, related to flow control technique. The method includes: after receiving Location request sent by LCS Client, LCS Server verifying whether the number of current Location request task is more than Maximum Location request task, if yes, LCS Server rejects to process current Location request; otherwise, LCS Server process the Location request. On the one hand, LCS Server can set different Maximum Location request task for different LCS Clients, and restrict Location request number sent by the LCS Client; on the other hand, LCS Server can control whether to continue processing subsequent Location request according to self processing capacity, so as to protect system performance security of LCS Server when facing collision of large number of Location requests.

### CROSS-REFERENCES TO RELATED APPLICATIONS

This is a continuation of International Application No. PCT/CN2004/000313, which was filed on Apr. 5, 2004, and which, in turn, claimed the benefit of Chinese Patent Application No. 03109249.7, which was filed on Apr. 7, 2003, the entire disclosures of which are hereby incorporated herein by reference.

### BACKGROUND OF THE DISCLOSURE

1. Field of the Technology

The present invention relates to flow control techniques and, more particularly, to a method for restricting location request flows in location service.

2. Background of the Invention

For Location Service (LCS) of mobile communication network, location information of target User Equipment (UE) is obtained through positioning technique, wherein UE demotes UE terminal to be positioned in mobile communication network, and position information can be expressed by either geographical latitude and longitude information or local location information, e.g. name of local streets. Location information obtained by LCS Server can be provided to target UE for self positioning; or provided to other client such as organizations and individuals, which requesting for location of target UE, as a Value-added service. Therefore, location service is a broad applied service in terms of emergency succor, vehicle guidance, intelligence traffic system, work dispatching, team management, mobile yellow page inquiry and network performance enhancement, etc. LCS specifications as well as function mode, structure, state description and message flow of the whole LCS Server are illustrated in The 3rd Generation Partnership Project (3GPP).

FIG. 1 is a schematic diagram illustrating logical structure of LCS network, as shown in FIG. 1, LCS Client 101 requests location information of UE 103 from the LCS Server 102, LCS Server 102 performs validity authentication to LCS Client 101, so as to check if target UE 103 allows LCS Client 101 to request location information thereof, if LCS Client 101 passes the validity authentication of LCS Server 102, LCS Server 102 will position the target UE and provide location information of target UE 103 to LCS Client 101; otherwise, LCS Server 102 will reject the request of LCS Client 101 to obtain location information of target UE 103.

At present, in LCS specification of 3GPP, when LCS Client is initiating a Location request to LCS Server, the Location request could be able to carry multiple target UE identifiers, which indicates LCS Client demands LCS Server to perform batch positioning to multiple target UE and then provide location information of multiple target UE to LCS Client, so that the number of Location request transmitted by LCS Client can be reduced, thus signaling load between LCS Client and LCS Server can be reduced and execution efficiency of Location request can be increased. However, there is neither flow restricting method of the received Location request is provided in the current LCS specification of 3GPP, nor processing mechanism of adjusting subsequent Location requests according to LCS Server's processing capacity in case of congestion, therefore, when LCS Client demands LCS Server to provide location information of multiple target UE, or when multiple LCS Clients send Location requests to LCS Server, LCS Server will confront collision of large amount of Location requests, and LCS Server may be led to paralysis due to insufficient processing capacity because of lack of flow control mechanism.

### SUMMARY OF THE INVENTION

In accordance with one aspect, a method is provided for restricting location request flows in location service, so that LCS Server can control number of location request which is to be processed and protect security of self processing performance.

To that end, a method is disclosed for restricting location request flows in location service, and including the following steps:
A. after receiving Location request sent by LCS Client, LCS Server verifies whether number of current Location request task is more than the Maximum Location request task, if yes, goes to step C, otherwise, goes to step B;
B. LCS Server processes the Location request;
C. LCS Server rejects to process the current Location request.

In some cases, said Maximum Location request task in step A is the Maximum Location request task of the LCS Client;
said step A is: after receiving Location request sent by LCS Client, LCS Server verifies whether the number of current Location request task sent by LCS Client is more than Maximum Location request task of this LCS Client, if yes, goes to step C, otherwise, goes to step B.

In some embodiments, said Maximum Location request task is set according to priority level of LCS Client.

In some cases, the Maximum Location request task in step A may be total Maximum Location request task in LCS Server;
said step A is: after receiving Location request sent by LCS Client, LCS Server verifies whether the total number current Location request tasks is more than total Maximum Location request task in LCS Server, if yes, goes to step C, otherwise, goes to step B.

In some cases, said Maximum Location request task in step A includes Maximum Location request task of LCS Client and total Maximum Location request task in LCS Server;
where said step A includes the following steps:
A1. after receiving Location request sent by LCS Client, LCS Server verifies whether the number of current Location request task sent by LCS Client is more than Maximum Location request task of the LCS Client, if yes, goes to step C, otherwise, goes to step A2;
A2. LCS Server verifies whether the total number of current Location request is more than total Maximum Location request task in LCS Server, if yes, goes to step C, otherwise, goes to step B.

In some cases, the method further includes after step C: LCS Server returns response message to the LCS Client that Location request is rejected.

In some cases, said step C further includes the following steps:
C1. LCS Server decides the reject mode is totally reject or partly reject, if totally, goes to step C2, if partly, goes to step C3;
C2. LCS Server directly rejects to process the current Location request, the flow control processing is finished;
C3. LCS Server accepts the current Location request in range of Maximum Location request task, and processes the accepted Location request.

In some cases, after said LCS Server directly rejects to process current Location request, said step C2 further includes: LCS Server returns response message to the LCS Client that Location request is rejected.

Said response message carrying corresponding error may cause value.

After said LCS Server accepts the current Location request in the range of Maximum Location request task, said step C3 may further include:
negotiating with the LCS Client of which Location request is rejected, determining whether to detain processing the rejected Location request or to cancel the operation.

Said total number current Location request tasks may include the number of to-be-processed Location request tasks and the number of under-processed Location request task.

In some cases, said total Maximum Location request task in LCS Server is the maximum number of Location request task confined by processing capacity of LCS Server.

According to one aspect of the present invention, on the one hand, LCS Server can set different Maximum Location request tasks for different LCS Clients, and restrict Location request number sent by LCS Client; on the other hand, LCS Server can control whether to process subsequent Location requests according to self processing capacity, thus protect system performance security of LCS Server in condition of substantive Location requests collision. Meanwhile, the above two schemes can be combined to better restrict flow, which can enhance integral performance security of LCS Server.

### BRIEF DESCRIPTION OF THE DRAWINGS

FIG. 1 is a schematic diagram illustrating logical structure of LCS network;

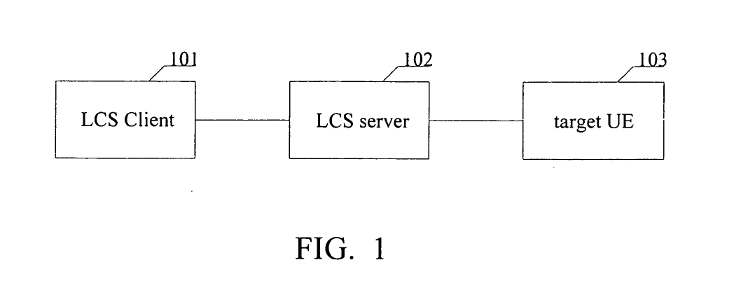

FIG. 2 is a flowchart illustrating flow restriction of LCS Client in the present invention;

FIG. 3 is a flowchart illustrating flow restriction of LCS Server in the present invention;

FIG. 4 is a flowchart illustrating combination of flow restriction in LCS Client and that in LCS Server in the present invention.

### DETAILED DESCRIPTION OF PREFERRED EMBODIMENTS

The present invention will be described in detail hereinafter with reference to the accompanying drawings.

LCS Server can restrict Location request task number sent by a certain LCS Client by setting Maximum Location request task corresponding to this LCS Client thereof in LCS Server. Maximum Location request task denotes the maximum task number that LCS Server allows a LCS Client to carry in terms of the transmitted Location request number. If more than one target UE identifier is comprised in a Location request, wherein each positioning request identified by each target UE identifier represents a Location request task, maximum task number means the maximum number of target UE identifiers which are carried in this Location request; if just only one target UE identifier is comprised in a Location request of a LCS Client, maximum task number means total number of times that this LCS Client can send a Location request to LCS Server.

LCS Server can perform different restrictions to Location request task quantities sent by different LCS Clients, namely Maximum Location request task can be set according to priority of a LCS Client, wherein larger Maximum Location request task is set for LCS Client with higher priority, and smaller Maximum Location request task is set for LCS Client with lower priority, for instance, LCS Client A is of higher priority than LCS Client B, thus Maximum Location request task of LCS Client A is set as 50, while that of LCS Client B is set as 20.

When receiving Location request sent by a LCS Client, at first LCS Server judges whether current to-be-processed task number of the received location information sent by the LCS Client exceeds Maximum Location request task of this LCS Client, if yes, LCS can directly reject current Location request of the LCS Client, returns failure response message which carries corresponding error cause value to LCS Client; LCS can also directly ignore current Location request sent by the LCS Client, and return no response message to LCS Client. Otherwise, LCS Server will process the current Location request sent by LCS Client.

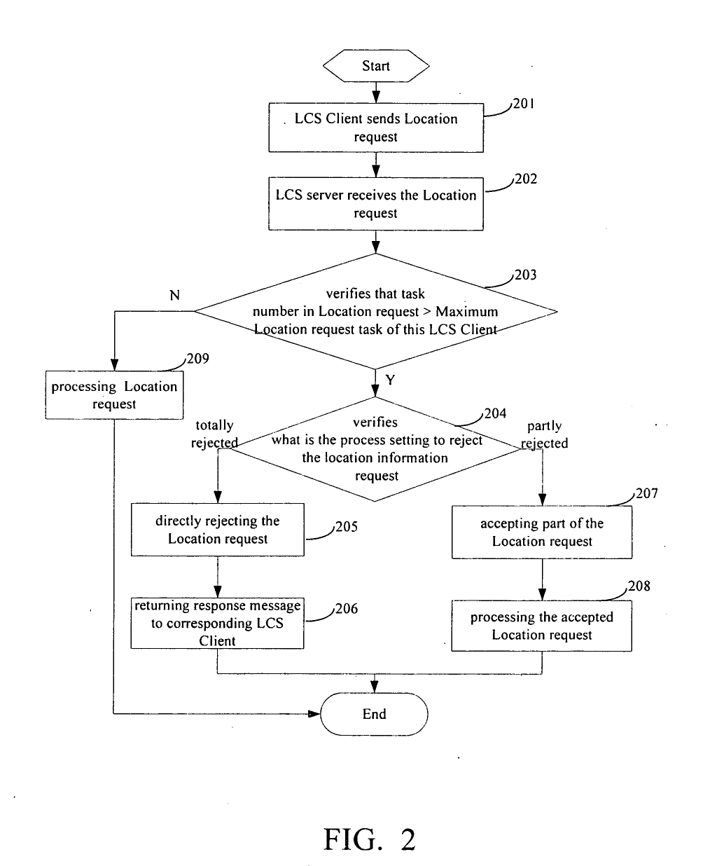

FIG. 2 is a flowchart illustrating flow restriction of LCS Client in the present invention, as shown in FIG. 2, process of LCS Client flow restriction comprises the following steps:

Step 201˜step 203: LCS Client sends Location request to LCS Server, after receiving the Location request, LCS Server judges whether Location request task number of the received location information is more than Maximum Location request task corresponding to this LCS Client, if yes, goes to step 204; otherwise, goes to step 209.

Step 204: LCS Server judges whether to totally or partly reject the request, if totally, step 205 is executed, if partly, step 207 is executed.

Step 205: LCS Server directly rejects the Location request sent by LCS Client.

Step 206: LCS Server returns response message to corresponding LCS Client, wherein the response message carries corresponding error cause value, and then ends current flow restriction process. This step can be omitted, namely LCS Server omits this Location request, returns no response message to corresponding LCS Client. If this step is omitted, after rejecting the Location request in step 205, LCS Server will directly end current flow restriction process. In addition, LCS Server may return response messages to part of the LCS Clients, for example, LCS Server only returns response message to the LCS Client with higher priority, as to that the LCS Client with lower priority, returns no response message, so as to save system resource.

Step 207˜step 208: LCS Server rejects part of the Location request, namely accepts part of the Location request, after performing subsequent process to the accepted Location request, ends current flow restriction process.

Step 209: after performing subsequent process to the Location request, LCS Server ends current flow restriction process.

For instance, LCS Server sets Maximum Location request task of LCS Client A as 40, LCS Client A sends Location request to LCS Server, wherein the Location request carries 50 target UE identifiers, requests LCS Server to position the 50 target UE and return location information of corresponding target UE to LCS Client A. Here, LCS Server detects that number of current Location request sent by LCS Client A is more than Maximum Location request task of LCS Client A, so LCS Server judges whether to totally or partly reject the request, if totally, LCS Server directly rejects the Location request sent by LCS Client, and can return response message to corresponding LCS Client, wherein the response message carries relevant error cause value; if partly, LCS Server accepts 40 target UE identifiers of the Location request, then position the 40 target UE, and provides location information of the corresponding 40 target UE to LCS Client A. LCS Server can randomly accept 40 target UE identifiers of the 50 target UE identifiers in this Location request, or orderly accept the first 40 target UE identifiers of this Location request, or accept 40 target UE identifiers of this Location request according to the setting, like setting priority level in terms of target UE and accepting the 40 target UE identifiers with higher priority levels. As for the rejected 10 target UE identifiers comprised in this Location request, LCS Server can negotiate with LCS Client, so as to determine whether to detain the process or cancel the operation in terms of current Location request. If it is determined to detain the process, LCS will delay a period of time before positioning the rejected target UE. If it is determined to cancel the operation, LCS Server will not position the rejected target UE.

Besides, LCS Server can set total Maximum Location request task according to its task processing capacity thereof, i.e. total task number of Location request that LCS Server is able to process. When LCS Server detects that the number of under-processed Location request task is close to the total Maximum Location request task, LCS Server can reject the total subsequent received Location requests, or partly reject the subsequent received Location requests according to the setting. When LCS Server detects that the number of under-processed Location request task is far smaller than total Maximum Location request task, LCS Server normally process the subsequent received Location requests.

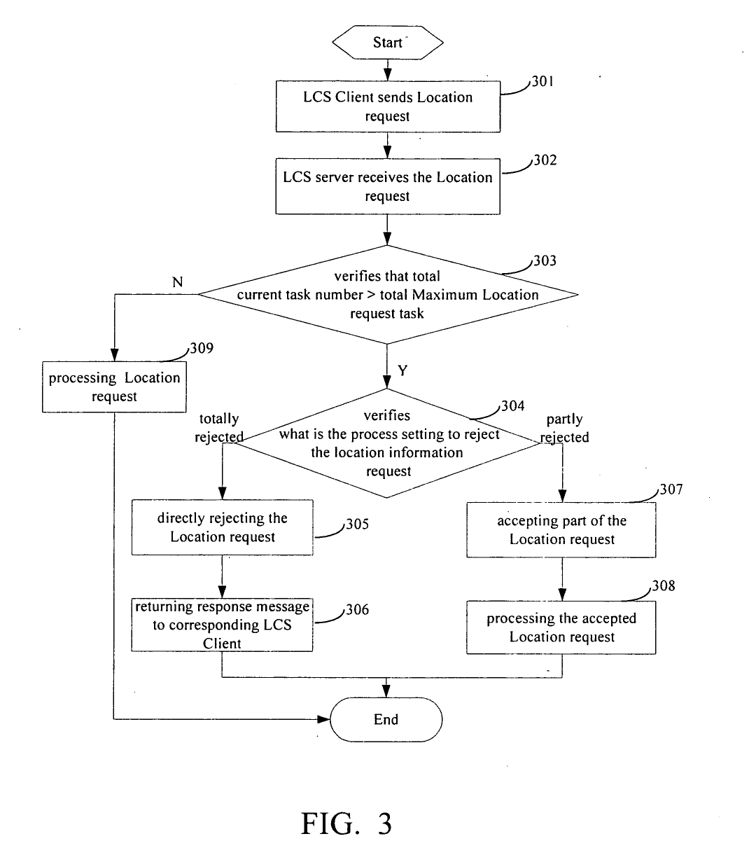

FIG. 3 is a flowchart illustrating flow restriction of LCS Server in the present invention, as shown in FIG. 3, process of LCS Server flow restriction comprises the following steps:

Step 301˜step 302: LCS Client sends Location request to LCS Server, after receiving the Location request, LCS Server judges whether total task number of current Location request is more than total Maximum Location request task, if yes, step 304 is executed; otherwise, step 309 is executed. Total task number of current Location request is composed of to-be-processed Location request task number and under-processed Location request task number.

Step 304˜step 309 are basically the same as step 204˜step 209.

For instance, total Maximum Location request task of LCS Server is 256, and under-processed task number is 240, here LCS receives 20 more different Location requests, and each Location request carries only one target UE identifier. Here, LCS Server detects that total task number of current Location request is more than total Maximum Location request task, so LCS Server judges whether to totally or partly reject the request, if totally, LCS Server directly rejects the 20 Location requests, and can return response message to corresponding LCS Client, wherein the response message carries relevant error cause value; if partly, LCS Server accepts 16 Location requests thereof, then process the 16 Location requests, position the corresponding 16 target UE, and provides location information of the corresponding target UE to corresponding LCS Client. LCS Server can randomly accept 16 Location requests of the 20 Location requests, or orderly accept the first 16 Location requests, or accept 16 Location requests according to the setting, like setting priority level in terms of target UE and accepting the 16 Location requests of target UE with higher priority levels. As for the rejected 4 Location requests, LCS Server can negotiate with LCS Client, so as to determine whether to detain the process or cancel the operation in terms of current Location requests. If it is determined to detain the process, LCS will delay a period of time before processing the 4 rejected Location requests. If it is determined to cancel the operation, LCS Server will not process the 4 rejected Location requests.

In order to better restrict Location request flow in location service, flow restriction of LCS Client and that of LCS Server can be combined for better application.

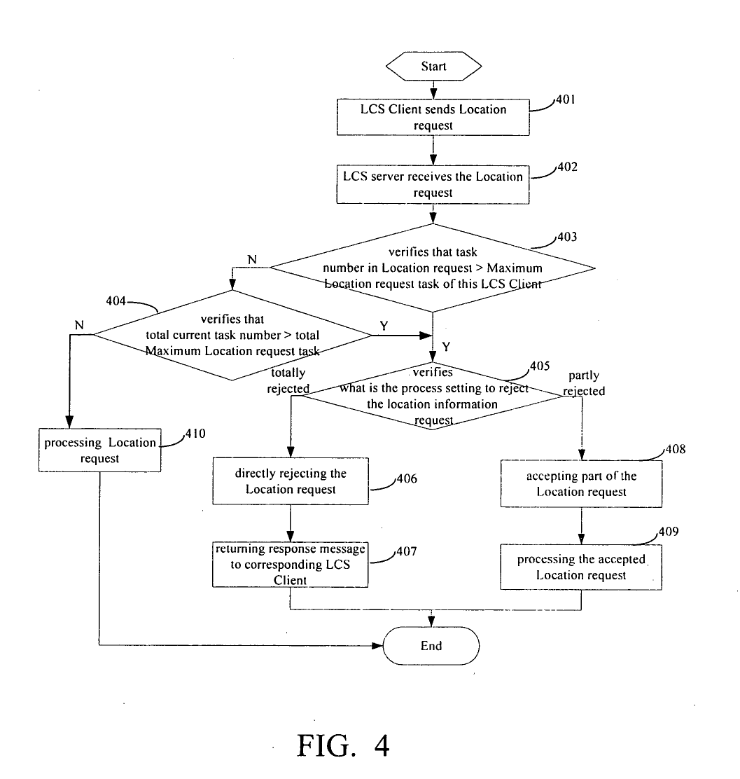

FIG. 4 is a flowchart illustrating combination of flow restriction in LCS Client and that in LCS Server in the present invention, as shown in FIG. 4, the process of combining flow restriction in LCS Client and that in LCS Server comprises the following steps:

Step 401˜step 402: LCS Client sends Location request to LCS Server, and LCS Server receives the Location request sent by LCS Client.

Step 403: after receiving the Location request, LCS Server judges whether Location request task number is more than Maximum Location request task corresponding to this LCS Client, if larger, step 405 is executed; otherwise, step 404 is executed.

Step 404: LCS Server judges whether total task number of current Location request is more than total Maximum Location request task in LCS Server, if larger, step 405 is executed; otherwise, step 410 is executed.

In fact, step 403 and step 404 can be exchanged.

Step 405˜step 410 are basically the same as step 204˜step 209.

For instance, total Maximum Location request task in LCS Server is 256, Maximum Location request task of LCS Client B is 20. Current under-processed task number in LCS Server is 250, LCS Client B sends Location request to LCS Server, wherein the Location request carries 10 target UE identifiers, and requests LCS Server to position the 10 target UE, and provide location information of the corresponding target UE for LCS Client B. Here, LCS Server detects that number of current Location request task sent by LCS Client B is smaller than Maximum Location request task of LCS Client B, LCS Server can further judges whether this Location request can be accepted according to current processing capacity, namely LCS Server can further judges whether to-be-processed task number will exceed total Maximum Location request task in LCS Server if the Location request is accepted, LCS Server detects that total task number of current Location request is more than total Maximum Location request task in LCS Server, as LCS Server is not able to process 10 tasks according to current processing capacity thereof, so LCS Server judges whether to totally or partly reject the requests, if totally, LCS Server directly rejects the 10 Location requests, and can return response message to LCS Client B, wherein the response message carries relevant error cause value; if partly, LCS Server accepts 6 Location requests thereof, then process the 6 Location requests, position the corresponding 6 target UE, and provides location information of the corresponding target UE to LCS Client B. As for the rejected 4 Location requests, LCS Server can negotiate with LCS Client B, so as to determine whether to detain the process or cancel the operation in terms of current Location request. If it is determined to detain the process, LCS will delay a period of time before processing the 4 rejected Location requests. If it is determined to cancel the operation, LCS Server will not process the 4 rejected Location requests.

In a word, the above description is just a preferable embodiment, not used to confine the protection scope of the present invention.

1. A method for restricting Location request flows in location service, comprising the following steps:
A. after receiving Location request sent by LCS (Location Service) Client, LCS Server verifies whether number of current Location request task is more than the Maximum Location request task, if yes, goes to step C, otherwise, goes to step B;
B. LCS Server processes the Location request;
C. LCS Server rejects to process the current Location request.

2. The method according to claim 1, wherein:
said Maximum Location request task in step A is the Maximum Location request task of the LCS Client;
said step A is: after receiving Location request sent by LCS Client, LCS Server verifies whether the number of current Location request task sent by LCS Client is more than Maximum Location request task of this LCS Client, if yes, goes to step C, otherwise, goes to step B.

3. The method according to claim 2, wherein said Maximum Location request task being set according to priority level of LCS Client.

4. The method according to claim 1, wherein:
the Maximum Location request task in step A is total Maximum Location request task in LCS Server;
said step A is: after receiving Location request sent by LCS Client, LCS Server verifies whether the total number current Location request tasks is more than total Maximum Location request task in LCS Server, if yes, goes to step C, otherwise, goes to step B.

5. The method according to claim 1, wherein:
said Maximum Location request task in step A comprises: Maximum Location request task of LCS Client and total Maximum Location request task in LCS Server;
said step A comprising the following steps:
A1. after receiving Location request sent by LCS Client, LCS Server verifies whether the number of current Location request task sent by LCS Client is more than Maximum Location request task of the LCS Client, if yes, goes to step C, otherwise, goes to step A2;
A2. LCS Server verifies whether the total number of current Location request is more than total Maximum Location request task in LCS Server, if yes, goes to step C, otherwise, goes to step B.

6. The method according to claim 1, wherein after step C, the method further comprises: LCS Server returns response message to the LCS Client that Location request is rejected.

7. The method according to claim 6, wherein in the step C2, after said LCS Server directly rejects to process current Location request, further comprising: LCS Server returns response message to the LCS Client that Location request is rejected.

8. The method according to claim 1, wherein said step C further comprises the following steps:
C1. LCS Server decides the reject mode is totally reject or partly reject, if totally, goes to step C2, if partly, goes to step C3;
C2. LCS Server directly rejects to process the current Location request; the flow control processing is finished;
C3. LCS Server accepts the current Location request in range of Maximum Location request task, and processes the accepted Location request.

9. The method according to claim 8, wherein in the step C2, after said LCS Server directly rejects to process current Location request, further comprising: LCS Server returns response message to the LCS Client that Location request is rejected.

10. The method according to claim 9, wherein said response message carrying corresponding error cause value.

11. The method according to claim 8, wherein step C3, after said LCS Server accepts the current Location request in the range of Maximum Location request task, further comprises:
negotiating with the LCS Client of which Location request is rejected, determining whether to detain processing the rejected Location request or to cancel the operation.

12. The method according to claim 4, wherein said total number current Location request tasks comprises the number of to-be-processed Location request tasks and the number of under-processed Location request task.

13. The method according to claim 5, wherein said total number current Location request tasks comprises the number of to-be-processed Location request tasks and the number of under-processed Location request task.

14. The method according to claim 4, wherein said total Maximum Location request task in LCS Server is the maximum number of Location request task confined by processing capacity of LCS Server.

15. The method according to claim 5, wherein said total Maximum Location request task in LCS Server is the maximum number of Location request task confined by processing capacity of LCS Server.
